(19) United States
(12) Patent Application Publication
(10) Pub. No.: US 2013/0025477 A1
(43) Pub. Date: Jan. 31, 2013

(54) PRESS MACHINE

(71) Applicant: Akihiro Yoshida, Gifu-shi (JP)

(72) Inventor: Akihiro Yoshida, Gifu-shi (JP)

(73) Assignee: Kabushiki Kaisha Yamada Dobby, Ichinomiya-shi (JP)

(21) Appl. No.: 13/492,676

(22) Filed: Jun. 8, 2012

(30) Foreign Application Priority Data
Jul. 27, 2011 (JP) 2011-163955

(51) Int. Cl. B30B 1/26; B30B 15/14

(52) U.S. Cl. 100/257; 100/282

(57) ABSTRACT

A press machine comprises: a crankshaft having plural eccentric shaft portions in the same phase; a slide, on which a die is to be held, disposed along the crankshaft and guided to be vertically movable; motion conversion mechanisms, in which adjusting means are, respectively, incorporated to make the bottom dead center position of the slide variable, provided in parallel between each eccentric shaft portion and the slide so as to convert the rotation of the crankshaft into the vertical motion of the slide; bottom dead center position detecting devices for detecting the dead center position of the slide at each of points spaced apart from each other in the longitudinal direction of the slide; and a control circuit for controlling the action of the adjusting means of one of the conversion mechanisms, based on a signal from each bottom dead center position detecting means.

### PRIORITY CLAIM

The instant application claims priority to Japanese Patent Application No. 2011-163955, filed Jul. 27, 2011, which application is incorporated herein by reference in its entirety.

### TECHNICAL FIELD

An embodiment of the subject matter relates to a press machine wherein a bottom dead center position of a slide which reciprocates with a rotation of a crankshaft is adjustable and, more particularly, to a press machine excellent in durability and capable of machining with high accuracy.

### BACKGROUND

In a press machine, a bottom dead center of a slide to which a cope of a press die is attached may sometimes shift upward or downward from its proper position due to heat generation and/or change in rotation frequency of a crankshaft during operation of the press machine. Such a shift of the bottom dead center position greatly affects the accuracy of products.

To prevent lowering in the accuracy of products due to this shift in the bottom dead center position, a press machine incorporating a bottom dead center position adjusting mechanism capable of adjusting the bottom dead center position of the slide is proposed (e.g., Japanese Patent Appl. Public Disclosure No. H5-111800, which is incorporated by reference).

In the conventional press machine, a connecting rod as a motion conversion mechanism for converting eccentric motion of a crankshaft into reciprocal linear motion of the slide is provided between the crankshaft and the slide to which a cope is to be attached. This connecting rod includes both split portions connected in series with each other through a pin. The pin is subjected to a lateral force from a swingable cylinder device. According to the press machine, it is possible, even during its operation, to change a flexion angle formed by both split portions of the connecting rod by actuation of the cylinder device, so that the bottom dead center position of the slide can be adjusted without causing complication of constitution and without interrupting the pressing action.

In such a press machine, in order to obtain a smoother vertical motion of the slide involving the rotation of the crankshaft, it may be conceivable to provide in parallel a connecting rod, i.e., a motion conversion mechanism with a bottom dead center position adjusting mechanism incorporated between the crankshaft and the slide.
[Patent Literature 1] Japanese Patent Appl. Public Disclosure No. H5-111800.

### SUMMARY

If, however, the conventional bottom dead center position adjusting mechanism is incorporated in each motion conversion mechanism which is provided in parallel, this tends to cause variation in the bottom dead center of each motion conversion mechanism due to a difference in influence of thermal expansion for each motion conversion mechanism, for example, to undergo during actuation of the press machine, or due to a difference in respective motion conversion mechanisms. As a result, it may become difficult to maintain a horizontal posture of this slide, and it becomes likely that, by an inclination from the horizontal posture of this slide, the accuracy in machining the products is impaired.

Further, in the conventional press machine, the pin of the connecting rod on which the cylinder device acts does not stand still during the actuation of the press machine, and becomes a moving point to draw a trajectory of complicated motions with the rotation of the crankshaft. Therefore, since comparatively complex external force acts on the cylinder device which exerts action force on the pin, there was a problem in durability of the press machine comprising the cylinder device.

Thus, an object of the subject matter is to realize a smooth vertical motion of a slide by use of a plurality of motion conversion mechanisms capable of adjusting the bottom dead center of the slide and to provide a press machine which allows more stable, highly accurate press machining by maintaining the horizontal posture of the slide with a high degree of accuracy.

Further, another object of the subject matter is to provide a press machine which is excellent in durability, which is capable of adjusting a bottom dead center of the slide without causing complication of the constitution and which allows a stable press machining with a high degree of accuracy.

The press machine according to the subject matter comprises: a frame; a crankshaft having a main shaft portion and a plurality of eccentric shaft portions made eccentric with each other in the same phase relative to the main shaft portion and spaced apart from each other in the axial direction of the main shaft portion; a slide disposed along the longitudinal direction of the crankshaft under the crankshaft to be guided by the frame to be movable vertically, and holding a die thereon; a plurality of motion conversion mechanisms which are provided in parallel between the corresponding eccentric shaft portion of the crankshaft and the slide so as to convert the rotation of the crankshaft into the vertical motion of the slide, each of the motion conversion mechanisms having adjusting means incorporated for making the bottom dead center position of the slide variable; a plurality of bottom dead center position detecting devices for detecting the bottom dead center position of the slide at each of at least two points spaced apart from each other in the longitudinal direction of the slide; and a control circuit for controlling the action of the adjusting means of at least one of the plural motion conversion mechanisms so as to maintain the levelness of the slide, based on an output signal from each bottom dead center position detecting means.

According to the press machine of the subject matter, when power is transmitted to the slide by an in-phase motion converting action of the plural motion conversion mechanisms which are provided in parallel, involving the rotation of the crankshaft, the slide properly reciprocates between a properly set bottom dead center position by the adjusting means of each motion conversion mechanism and a top dead center position. For instance, if a shift occurs in the bottom dead center position of the slide defined by each motion conversion mechanism due to heat generation during operation of the press machine accompanied by the reciprocation of the slide, the control circuit controls the action of the adjusting means of at least one of the motion conversion mechanisms, based on an output signal from the bottom dead center position detecting device so that the control circuit can maintain the levelness of the slide.

Thus, even in the presence of some influence of the temperature of each motion conversion mechanism or a difference or the like in performance characteristic of the adjusting means incorporated in each of the motion conversion mechanisms, the horizontal posture of the slide can be securely held by the action of the adjusting means under the control of the control circuit. This enables the plural conversion mechanisms to make the slide move up and down smoothly and to hold the horizontal posture of the slide, thereby realizing a stable high accuracy press machining.

Each motion conversion mechanism can comprise: a connection member rotatably connected with the corresponding eccentric shaft portion; a link member whose one end is connected with the connection member through a first pivot disposed in parallel to the crankshaft and whose other end is connected with the slide through a second pivot disposed in parallel to the first pivot; a swing arm connected with the connection member through a third pivot spaced apart from the first pivot and disposed in parallel to the first pivot; a fourth pivot disposed in parallel to the first pivot and combined with the swing arm at an interval from the third pivot; and adjusting means for positioning the fourth pivot displaceably.

According to the motion conversion mechanism, the swing arm is connected through the third pivot with the connection member which tends to generate eccentric motion with the rotation of the crankshaft. This swing arm is permitted to swing with the fourth pivot as a fulcrum. Accordingly, when the crankshaft rotates, the connection member and the swing arm produce link motion with the fourth pivot as a fulcrum, and the motion of the connection member is regulated by the swing arm.

Since the motion of the connection member, whose motion is regulated by this swing arm, is transmitted to the slide as a linear reciprocating motion through the first pivot and the link member, the slide performs linear reciprocating motion.

Also, when the position of the fourth pivot as a fulcrum of the link motion of the connection member and the swing arm is changed by action of the adjusting means, the swing angle of the connection member changes, following the change of the link motion. This results in a change in the displacement component in the height direction of the first pivot which becomes a connecting point of the connection member and the link member and brings about changes in the top dead center and the bottom dead center positions in a reciprocating motion. As a result, the bottom dead center position of the slide is changed by the positioning mechanism.

Thus, the bottom dead center position of the slide can be changed by changing the fourth pivot position which becomes a rest point relative to the linear reciprocating motion of the slide. Accordingly, without adding such pressure as heretofore to the positioning mechanism and by means of a comparatively simple link mechanism, it is possible to adjust the bottom dead point position of the slide even during operation of the press machine.

It is desirable to dispose the first pivot below the crankshaft. Also, it is desirable to dispose the fourth pivot above the third pivot and to dispose the second pivot on the vertical center line of the slide. The third pivot is disposed at a position off an imaginary line connecting the first pivot and the eccentric shaft portion.

An imaginary line connecting the center line of the first pivot, the center line of the eccentric shaft portion and the center line of the third pivot can be arranged to draw a right triangle such that the side connecting the center line of the first pivot and the center line of the eccentric shaft portion, and the side connecting the center line of the eccentric shaft portion and the center line of the third pivot form a right angle.

The connection member can be constituted by a plate-like member including: a central part with an opening for rotatably receiving the eccentric shaft portion; a first flared portion extending downward from the central portion; and a second flared portion extending in a lateral direction orthogonal to the first flared direction from the central part. In that case, it is possible to provide the first flared portion and the second flared portion, respectively, with the first pivot and the third pivot.

In a case where the above-mentioned opening is formed in the connection member, the first pivot can be disposed in the link member below the opening, and the third pivot in the link member beside the opening.

The adjusting means can include a shaft member disposed to project inward from the outside of the frame. The shaft member is axially movable relative to the frame and can be positioned. The fourth pivot is supported at a projected end into the frame of the shaft member.

For the adjusting means, a male screw can be formed at a part located outward of the frame of the shaft member, and the adjusting means can include: a worm wheel having an inside screw to be screwed into the male screw of the shaft member and an external tooth, and supported rotatably on the frame at a fixed position; a worm to mesh with the external tooth of the worm wheel; and a driving device for rotating the worm under control of the control circuit so as to adjust the axial position of the shaft member by rotating the worm wheel.

According to the subject matter, as mentioned above, it is possible to have the plural motion conversion mechanisms move the slide up and down smoothly and hold the horizontal posture of the slide, thereby enabling a stable high-accuracy press machining.

Further, according to the subject matter, the bottom dead center position of the slide can be changed by changing the fourth pivot position which becomes a rest point relative to the liner reciprocating motion of the slide. Therefore, a comparatively simple link mechanism enables improvement of the durability of the press machine capable of adjusting the bottom dead center point of the slide even during operation.

### BRIEF DESCRIPTION OF THE DRAWINGS

FIG. 1 is a partially exploded front view showing a press machine according to a first embodiment.

FIGS. 2(a) and (b) are side views, in which (a) shows a state where the bottom dead center position of the slide is uppermost, and (b) shows a state where the bottom dead center position of the slide is lowermost.

FIG. 3 is a cross-sectional view obtained along the line III-III in FIG. 2(a).

FIG. 4 is a block diagram of the electric circuit of the press machine shown in FIG. 1.

FIG. 5 is a cross-sectional view of a press machine according to another embodiment, similar to FIG. 2(a)

### DETAILED DESCRIPTION

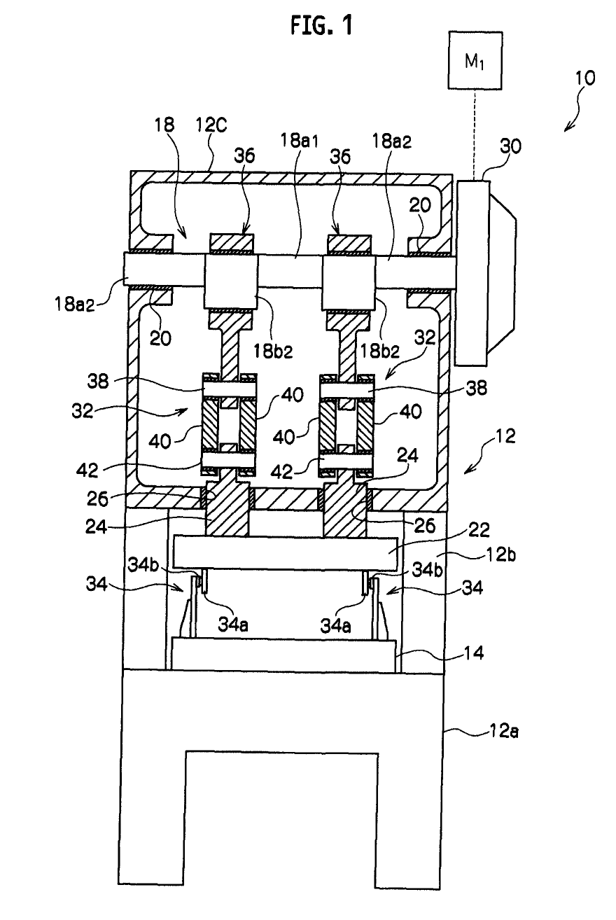

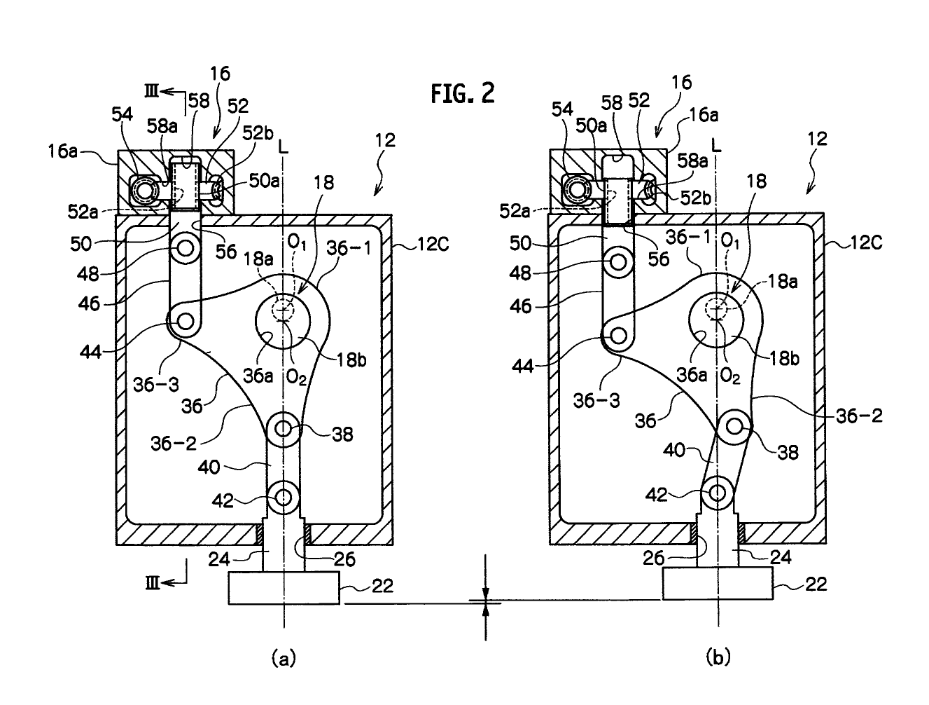

The press machine 10, as shown in FIG. 1, comprises a frame 12. The frame 12 has a lower frame 12a for supporting a bolster 14 on which a drag of a press die (not shown) is disposed, and an upper frame 12c supported at an interval through a pillar portion 12b on a lower frame 12a. The upper frame 12c is a crown portion including a generally rectangular enclosure, and as shown in FIG. 2, on top of the crown portion is provided a housing 16a for each adjusting means 16, which is to be described later.

In the crown portion 12c, a crankshaft 18 is disposed in a horizontal direction. In the embodiment shown in FIG. 1, the crankshaft 18 has three main shaft portions 18a (18a1, 18a2, 18a2) disposed with their axes coincided mutually and at intervals from one another in the axial direction, and two eccentric shaft portions 18b and 18b interposed between the three main shaft portions and disposed eccentrically on the main shaft portion 18a. The eccentric shaft portions 18b, 18b are formed in pairs in the same phase between a pair of sideward main shafts 18a2 and 18a2 at an interval to oppose each of the eccentric shaft portions 18b and 18b, which form integrally a crankshaft 18. Therefore, the pair of sideward main shafts 18b, 18b are formed at an interval in the axial direction of the crankshaft 18, i.e., the axial direction of the main shaft portion 18a (18a1, 18a2, 18a2). The crankshaft 18 is supported by the bearing 20 of the crown portion 12c at the pair of sideward main shaft portions 18a2, 18a2 on the frame 12 rotatably about the axis of the crankshaft 18.

The slide 22 in which the cope of the die is to be incorporated is disposed below the upper frame 12c as shown in FIG. 1 such that the longitudinal direction of the slide 22 is along the axial direction of the crankshaft 18. To the slide 22 are secured a pair of connecting rods 24 which are disposed at an interval from each other in the longitudinal direction of the slide. At the lower part of the crown portion 12c, a through hole 26 for each of the pair of connecting rods 24 is formed to correspond to the position where each of the eccentric shaft portions 18b, 18b is provided on the axis of each of crankshaft 18. The pair of connecting rods 24 penetrate the corresponding through hole 26 from the inside of the crown portion 12c approximately perpendicularly, and the lower end of each connecting rod 24 is integrally attached to the slide 22. The connecting rods 24 are guided vertically by the through holes 26, whereby the slide 22 is guided to perform vertical reciprocation. The pair of connecting rods 24 can be integrally formed with the slide 22 as a part thereof.

In one of the sideward main shaft portions 18a2 of the crankshaft 18 is provided a flywheel 30 to receive the drive force of a main motor M1 such as an electric motor. When the main motor M1 is driven, the crankshaft 18 is driven to rotate in one direction by inertia of the flywheel 30 at a stable rotational speed. In the flywheel 30, though not shown, a clutch and a brake well known heretofore are incorporated.

In order to convert the rotation of the crankshaft 18 into vertical motion of the slide 22 via the pair of connecting rods 24, a motion conversion mechanism 32 including the link mechanism is provided between each of eccentric portions 18b and 18b and corresponding pairs of connection rods 24, respectively.

In the illustration, a pair of motion conversion mechanisms 32 are provided to correspond to the two eccentric shaft portions 18b, 18b. Each motion conversion mechanism 32 connects a pair of eccentric shaft portions 18b and 18b with the upper ends of the pair of connection rods 24. Each motion conversion mechanism 32, as described later, converts the eccentric motion in the same phase of each eccentric shaft portion 18b, 18b into the vertical motion of the corresponding connecting rod 24 and transmits to the slide 22. In addition, adjusting means 16 (see FIG. 2) for adjusting the bottom dead center of the slide 22 is incorporated in each motion conversion mechanism 32, thereby enabling adjustment of the bottom dead center position of each motion conversion mechanism 32 and the connecting rod 24, i.e., the bottom dead center position of the slide 22 by adjusting the bottom dead center of the slide 22.

Between the slide 22 and the bolster 14, relative to adjustment of the bottom dead center position by each adjusting means 16, a pair of bottom dead center position detecting devices 34 are provided to detect the bottom dead center position of the slide 22.

A heretofore well-known magnetic detecting device for magnetically detecting, e.g., a position may be used for each bottom dead center position detecting device 34. The pair of magnetic detecting devices 34 have a pair of magnet devices 34a which are supported on the bottom face of the slide at an interval, e.g., in the longitudinal direction of the slide 22, and a pair of magnetic sensors 34b supported on the bolster 14 opposite to the magnet devices so as to detect the magnetism of the corresponding magnet device 34a. Each magnet device 34a is not shown, but as known heretofore, has multiple permanent magnets aligned vertically, for example, with their magnetic poles alternately reversed, and the magnetic sensors 34b detect changes in the magnetic poles of the permanent magnets, thereby outputting information signals on the height position of the slide 22. Each magnetic detecting device 34 can detect a shift of about 1 μm in height.

The magnetic detecting devices 34a can be arbitrarily supported on the side faces of the slide 22 or on the side faces of the cope of the die, and the magnetic sensors 34b can be arbitrarily supported on the pillar portions 12b of the frame 12 or on the side faces of the drag.

The pair of motion conversion mechanisms 32 include link mechanisms of the same configuration parallel to each other. Therefore, the following discussion relates mainly to one of the motion conversion mechanisms, i.e., the link mechanisms 32.

Each link mechanism 32 includes, as clearly shown in FIGS. 2(a) and (b), a connection member 36 rotatably connected with the corresponding eccentric shaft portion 18b of the crankshaft 18, and a link member 40 connected with the connection member 36 through the first pivot 38 parallel to the main shaft portion 18a, the link member being connected with the connecting rod 24 of the slide 22 through the second pivot 42 parallel to the main shaft portion 18a.

The connection member 36 of each link mechanism 32 has, as clearly shown in FIGS. 2(a) and (b), a central part 36-1 where an opening 36a for rotatably receiving each corresponding eccentric shaft portion 18b, a first flared portion 36-2 extending downward from the central part as viewed in FIG. 2(a), and a second flared portion 36-3 extending from the central part 36-1 in a lateral direction orthogonal to the extending direction of the first flared portion 36-2. The first pivot 38 is supported on the first flared portion 36-2, and a third pivot 44 parallel to the first pivot 38 is supported on the second flared portion 32-3.

As shown in FIG. 1, the link members 40 of the respective link mechanisms 32 are provided in pairs. A pair of link members 40 are disposed at an interval from each other so as to interpose between their upper ends the first flared portion 36-2 (see FIGS. 2(a) or (b)) of the corresponding connection member 36, and so as to interpose the upper end of the corresponding connecting rod 24 between the lower ends. The pair of link members 40 are connected with the corresponding connecting rods connected with the corresponding to connection rods 24 through the second pivot 42 at the lower end. Because of this, each connection member 36 of each link mechanism 32 is connected with the slide 22 through the link member 40.

As shown in FIG. 2(a) and FIG. 2(b), the first pivot 38 of each link mechanism 38 is located below the crankshaft 18, and the second pivot 42 is located below the first pivot 38. Further, an imaginary line connecting the center line of the first pivot 38, the center line O2 of the eccentric shaft portion 18b, and the center line of the third pivot 44 draws a right triangle such that the side connecting the center line of the first pivot 38 and the side connecting the center line O2 of the eccentric shaft portion and the center line O2 of the eccentric shaft portion and the side connecting the center line O2 of the eccentric shaft portion and the center line of the third pivot 44 form a right angle.

In the rotational posture of the crankshaft 18 shown in FIG. 2(a) and FIG. 2(b), both center lines O1 and O2 align on a perpendicular line such that the center line O1 of the main shaft portion 18a is located right above the center line O2 of the eccentric shaft portion 18b. Also, when the crankshaft 18 is in this rotating posture, in the embodiment shown in FIG. 2(a), both center lines O1 and O2, the central axis extending from the central part 36-1 to the first flared portion 36-2 (the line connecting the center line O2 and the center of the first pivot 38), and the central axis of the link member 40 (the line connecting the center of the first pivot 38 and the center of the second pivot 42) are on the perpendicular center line L of the press machine 10 which coincides with the center line of the slide 22, so that the first pivot 38 and the second pivot 42 align on this perpendicular center line L. The arrangement enabling alignment on such a perpendicular center line L is advantageous for ensuring a balance in the action of the press machine 10.

Also, as shown in FIG. 2(a), when the first pivot 38 and the second pivot 42 align on the perpendicular center line L, the third pivot 44 is set to be at the same height position as the center line O2 of the eccentric shaft portion 18b.

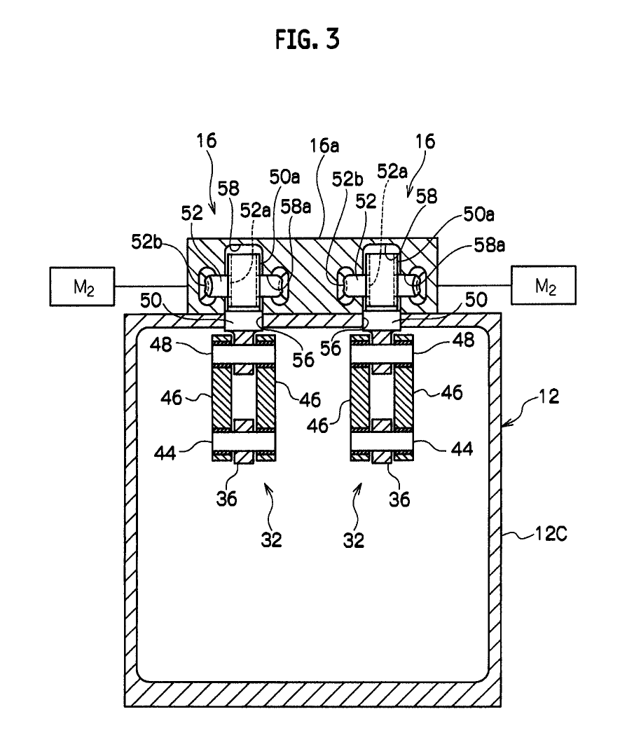

The third pivot 44 of each link mechanism 32 is provided at the connection member 36 so as to be parallel to the eccentric shaft portion 18b at a position shifted toward one side from the center line L. In addition, when the first pivot 38 and the second pivot 42 align on the perpendicular center line L, the third pivot 44 is at approximately the same height position as the center line O1 of the main shaft portion 18a. Both ends of the third pivot 44 of each link mechanism 32 are, as shown in FIG. 3, combined with the lower ends of a pair of swing arms 46 arranged in parallel to each other. The fourth pivot 48 parallel to the eccentric portion 18b is combined with the upper ends of the pair of swing arms 46, and each adjusting means 16 is provided in relation to the pivot 48.

Each adjusting means 16 has, in the illustration, a male screw 50a at the upper end portion, and has a shaft member 50 in which the lower end portion is disposed so as to be able to project from the housing 16a provided on the top of the crown portion 12c into the crown portion 12c, a worm wheel 52 to screw with the male screw 50a of the shaft member, and a worm 54 to mesh with the worm wheel 52 (see FIGS. 2(a) and (b)).

In FIG. 3, the housing 16a of the adjusting means 16 of each link mechanism 32 is integrally formed, but each housing 16a may be formed separately. In each housing 16a, a guide hole 58 is formed to fit to the opening 56 of the crown portion 12c for receiving the shaft member 50 of each adjusting means 16 so as to be able to project. The shaft member 50 has the male screw portion provided with the male screw 50a, the male screw portion being received in the guide hole 58 movably in the axial direction of the shaft member 50, and the corresponding fourth pivot 48 is supported at the projecting end.

In the housing 16a is formed a radially expanded portion 58a in relation to the guide hole 58. In this radially expanded portion 58a, a worm wheel 52 is held rotatably. The worm wheel 52 has an inside screw 52a to engage with the male screw portion 50a and also has an external tooth. The worm wheel 52 is prevented from moving in the axial direction of the shaft member 50 by a shoulder of the radially expanded portion 58a. With the external tooth 52b of the worm wheel 52 is meshed the worm 54, which is borne rotatably within the housing 16a.

The worm 54 of the adjusting means of each link mechanism 32 is rotatable by a drive source such as an electric servo motor M2 for adjustment. Therefore, by actuating the electric servo motor M2 of each link mechanism 32 to rotate the corresponding worm 54 and by rotating the worm wheel 52, which meshes with the worm, at a fixed position, it is possible to displace the shaft member 50 of each link mechanism 32, which meshes with the worm wheel 52, in the axial direction of the shaft member.

FIG. 2(a) shows a state where the shaft member 50 is placed at a setback position, the deepest in the guide hole 58 of the shaft member 50, by rotational operation of the worm 54 of each link mechanism 32. FIG. 2(b) shows a state where the shaft member 50 is at a projected position, the most projected from the guide hole 58, by reverse rotational operation of the worm 54.

At the setback position of this shaft member 50, the fourth pivot 48 supported on the shaft member 50 in each link mechanism 32 is held at the uppermost setback position as viewed in FIG. 2(a), while at the projected position, the fourth pivot 48 is held at the lowermost position as viewed in FIG. 2(b). Also, in both FIGS. 2(a) and 2(b), the center line O1 of the main shaft portion 18a being located right above the center line O2 of the eccentric shaft member 18b, the slide 22 is at the bottom dead center position by synchronous actuation of each link mechanism 32 in this rotational posture of the crankshaft 18.

According to the press machine 10 in the subject matter, it is possible to change the position of the fourth pivot 44, for example, from the position shown in FIG. 2(a) to the position shown in FIG. 2(b) by action of the servo electric motor M2 for adjustment of the adjusting means 26 of each link mechanism 32. The servo electric motor M2 of both such link mechanisms 32 can control the actuation synchronously or individually.

In any case, if the height position of the fourth pivot 48 is changed, for example, from the position shown in FIG. 2(a) to the position shown in FIG. 2(b) by actuation of the servo electric motor M2 of the corresponding link mechanism 32, the connection member 36 of the corresponding link mechanism 32 is rotated counterclockwise about the eccentric shaft portion 18b from the posture shown in FIG. 2(a) toward the posture shown in FIG. 2(b) through the pair of swing arms 46. When the height position of the first pivot 38 which supports the link member 40 is raised with the change in rotational posture of the connection member 36, the bottom dead center position of the slide 22 is elevated by S from the position shown in FIG. 2(a) to the bottom dead center position shown in FIG. 2(b).

Therefore, it is possible to adjust the bottom dead center position of the slide 22 to an optimum value by synchronous actuation of both servo electric motors M2 for adjustment.

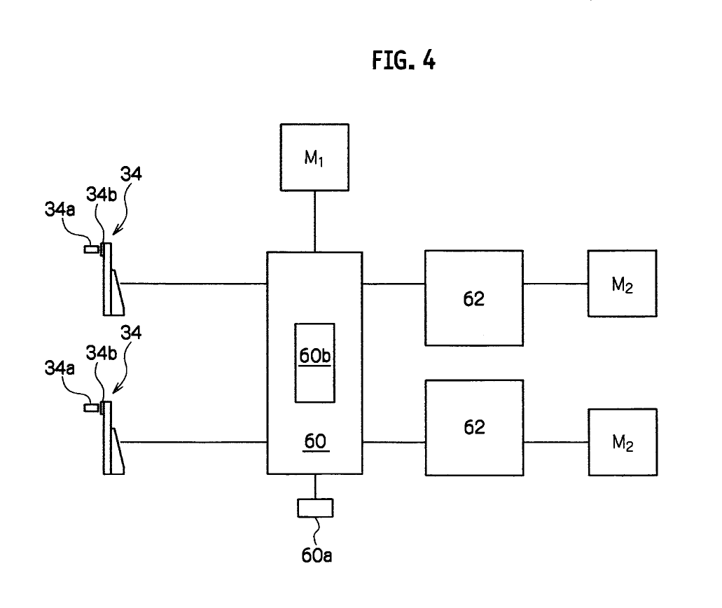

In FIG. 4 is shown a control system 100 for the main electric motor M1 and the servo electric motor M2 for adjustment in a block diagram. The control system 100 includes a control circuit 60 for controlling the actuation of the main electric motor M1 and the servo electric motor M2 for adjustment. The control circuit 60 drives the main electric motor M1 under a predetermined operating condition based on input signals of an operation input portion 60a. Also, the control circuit 60 has an arithmetic circuit portion 60b for calculating a shift in the bottom dead center position at both detection points on the basis of the bottom dead center position information from the magnetic sensor 34b of each bottom dead center position detecting device 34. The control circuit 60 can actuate the servo electric motor M2 for adjustment via the corresponding correction amount instructing circuit 62 on the basis of the computational decisions of the arithmetic circuit portion 60b. Further, the control circuit 60 can control individually or synchronously the servo electric motor M2 for adjustment of each link mechanism 32 via the correction amount instructing circuit 62 so as to set a predetermined bottom dead center position in a state where the horizontal posture of the slide 22 is held, on the basis of an initialized signal on a bottom dead center position from the operation input portion 60a. With this initialization, it is possible to utilize an output signal from each bottom dead center point detecting device 34.

After initializing a desired bottom dead center position, the crankshaft 18 can be rotated by tying the clutch while the main electric motor M1 is being actuated. This rotation of the crankshaft 18 makes the pair of eccentric portions 18b perform eccentric motion synchronously and in the same phase. At this time, the pair of swing arms 46 connected with the connection member 36 of each link mechanism 32 are permitted to perform a swinging motion with the fourth pivot 48 as the center. Therefore, when the crankshaft 18 rotates, the connection member of each link mechanism 32 and the swing arms 46 cause link motion with the fourth pivot 48 as the fulcrum, and the motion of the connection member 36 is regulated by the pair of swing arms 46.

Integral motion of the connection member 36 of each link mechanism 32 whose motion is regulated by the swing arms 46 is transmitted to the slide 22 as linear reciprocation via the link member 40 connected with the corresponding first pivot 38 and the link. Thus, with the synchronous actuation of each link mechanism 32, the slide 22 performs vertical motion in the horizontal posture at the initialized desired bottom dead center position, whereby the press machine 10 starts the usual pressing action.

During the usual operation of the press machine 10, if the heat generation causes a shift to be generated in the bottom dead center position of the slide initialized by each motion conversion mechanism 32 because of a difference in thermal expansion due to, for example, a difference in temperature, the slide 22 is caused to incline from the horizontal posture. The information on this inclination is inputted by the arithmetic circuit portion 60b of the control circuit 60 as an output signal from the pair of magnetic sensors 34b. The arithmetic circuit portion 60b, upon receipt of the signal from the pair of magnetic sensors 34b, calculates a corrected value with the signal value of one of the pair of magnetic sensors 34b as a reference. Based on this corrected amount, in order to maintain the horizontal posture of the slide 22, the control circuit 60 actuates via the corresponding corrected amount instruction circuit 62 the other servo electric motor M2 located on the opposite side of the one side which is made a reference.

By this actuation of the servo electric motor M2 for adjustment, the corresponding adjusting means 16 of the corresponding link mechanism 32 corrects the shift in the bottom dead center position of the link mechanism, as mentioned above. By this correcting action, even in the course of the actuation of the slide 22, the fourth pivot 48 is placed in a state of rest, and the height position of the fourth pivot 48 in the state of rest is adjusted by the actuation of the servo electric motor M2 for adjustment between the backward position and projected position so as to hold the horizontal posture of the slide 22. Thus, with no complex external force acting on the adjusting means 16, the durability of the adjusting means is enhanced, thereby improving the durability of the press machine 10.

Making the bottom dead center positions of both link mechanisms 32 identical to hold the horizontal posture of the slide 22 at the bottom dead center position sometimes results in a slight difference, for example, of several μm to several dozen μm in the stroke length of both link mechanisms 32. However, no problem has arisen from such a small difference in the stroke length between both link mechanisms 32 in the action of the press machine 10.

In what is mentioned above, the horizontal posture of the slide 22 was controlled, making one signal value from the pair of magnetic sensors 34b a reference, and actuating the other servo electric motor M2 located on the opposite side of the one side as the reference. In place of this example, it is possible to adopt the initialized bottom dead center position as a reference value. In such a case, it is possible to hold the horizontal posture of the slide 22 at the initialized bottom dead center position by actuating both adjusting means 16 on the basis of a comparison between the initialized reference value and a value obtained from the height information from the pair of magnetic sensors 34b.

It is possible to arbitrarily adopt an adjusting means using a drive source, such as a cylinder device, as the adjusting means 16.

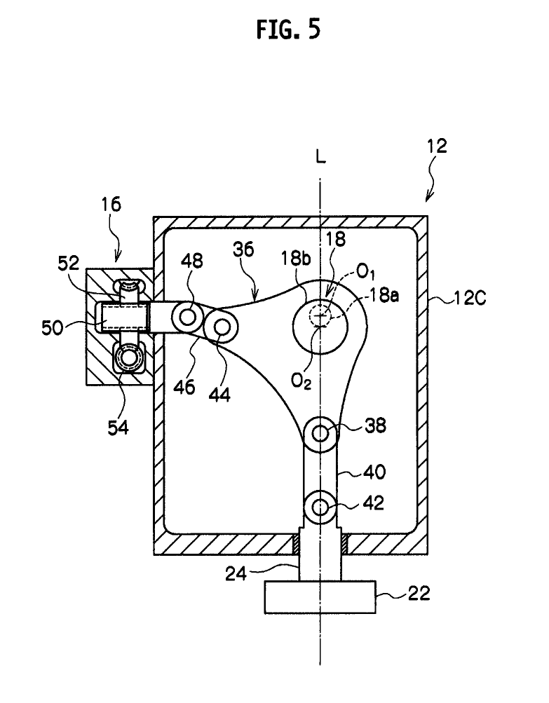

In FIGS. 2(a) and (b) is shown an embodiment in which the housing 16a of the adjusting means 16 is disposed on the top of the crown portion 12c, but as shown in FIG. 5, the adjusting means 16 can be disposed on a side portion of the crown 12c. The adjusting means 16 shown in FIG. 5 is the same as the adjusting means 16 shown in FIG. 2(a) with the exception that the locations to dispose the housing 16a for accommodating the shaft member 50, worm wheel 52, worm 54 and the like are changed to the side portion of the crown portion 12c, that with this change, the length of the pairs of swing arms 46 and the posture relating to the crown position 12c are changed, and that the disposing angle of each member 50, 52 and 54, etc., relative to the crown portion 12c is changed by 90°.

The described subject matter is not limited to the above embodiments but may be altered in various ways, such as, for example, changing the location of each pivot, without departing from the spirit and scope presented here.

Also, for example, in place of the magnetic detecting device 34, it is possible to use various position detecting devices on the market such as, for example, an optical positioning detecting device or a position detecting device utilizing eddy current. Further, in place of a pair of motion conversion mechanisms 32, three or more motion conversion mechanisms can be disposed in parallel between the crankshaft and the slide. Further, it is possible to adopt various motion conversion mechanisms incorporating adjusting means which make the bottom dead center positions variable.

What is claimed is:

1. A press machine comprising:
a frame;
a crankshaft having a main shaft portion and a plurality of eccentric shaft portions made eccentric in the same phase with each other relative to the main shaft portion and spaced apart from each other in the axial direction of the main shaft portion;
a slide disposed under the crankshaft and along the longitudinal direction of the crankshaft, and also guided by the frame to be vertically movable and on which a die is held;
a plurality of motion conversion mechanisms which are provided in parallel between the corresponding eccentric shaft portion of the crankshaft and the slide so as to convert the rotation of the crankshaft into the vertical motion of the slide and in which adjusting means are, respectively, incorporated to make the bottom dead center position of the slide variable;
a plurality of bottom dead center position detecting devices for detecting the bottom dead center position of the slide at each of at least two points spaced apart from each other in the longitudinal direction of the slide; and
a control circuit for controlling the action of the adjusting means of at least one motion conversion mechanism of the plural motion conversion mechanisms so as to maintain the levelness of the slide, based on an output signal from each bottom dead center position detecting means.

2. The press machine according to claim 1, wherein each motion conversion mechanism comprises:
a connection member connected rotatably with the corresponding eccentric shaft portion;
a link member whose one end is connected with the connection member through a first pivot disposed in parallel to the crankshaft and whose other end is connected to the slide through a second pivot disposed in parallel to the first pivot;
a swing arm connected with the connection member through a third pivot spaced apart from the first pivot and disposed in parallel to the first pivot;
a fourth pivot disposed in parallel to the first pivot and spaced apart from the third pivot to be combined with the swing arm; and
adjusting means for positioning the fourth pivot displaceably.

3. The press machine according to claim 2, wherein the adjusting means comprises a shaft member disposed to project inward from the outside of the frame and movable in the axial direction relative to the frame, wherein the fourth pivot is supported at the projected end from outside the frame into the frame of the shaft member, and wherein the shaft member is positioned movably in its axial direction relative to the frame.

4. The press machine according to claim 3, wherein a male screw is formed in the shaft member in a part located in the outside of the frame, wherein the adjusting means further includes: a worm wheel having an inside screw screwed into the male screw of the shaft portion and an external tooth and supported on the frame rotatably at a fixed position; a worm to mesh with the external tooth of the worm wheel; and a driving device for rotating the worm under control of the control circuit so as to adjust the axial position of the shaft member by rotating the worm wheel through the worm.

5. The press machine according to claim 2, wherein the link member is connected with the connection member through the first pivot below the crankshaft.

6. The press machine according to claim 2, wherein the third pivot is provided in the connection member at a position off an imaginary line connecting the first pivot and the center of the eccentric shaft portion.

7. The press machine according to claim 2, wherein an imaginary line connecting the center line of the first pivot, the center line of the eccentric shaft portion and the center line of the third pivot draws a right triangle forming a right angle between the side connecting the center line of the first pivot with the center line of the eccentric shaft portion and the side connecting the center line of the eccentric shaft portion with the center line of the third pivot.

8. The press machine according to claim 2, wherein the connection member includes:
a central portion having an opening for rotatably receiving the eccentric shaft portion;
a first flared portion flared downward from the central portion; and
a second flared portion flared from the central portion in a lateral direction orthogonal to the flared direction of the first flared portion, wherein the first flared portion and the second flared portion are provided with the first pivot and the third pivot, respectively.
